(19) United States
(12) Patent Application Publication
(10) Pub. No.: US 2026/0081484 A1
(43) Pub. Date: Mar. 19, 2026

(54) SYSTEM AND METHODS FOR DETECTION OF MISALIGNMENT IN A WIRELESS POWER TRANSFER

(71) Applicant: Purdue Research Foundation, West Lafayette, IN (US)

(72) Inventors: Dionysios Aliprantis, West Lafayette, IN (US); Aaron D. Brovont, West Lafayette, IN (US); Vatan Chandrakant Mehar, West Lafayette, IN (US); Steven D. Pekarek, West Lafayette, IN (US); Robert R SWANSON, Lafayette, IN (US)

(73) Assignee: Purdue Research Foundation, West Lafayette, IN (US)

(21) Appl. No.: 19/334,461

(22) Filed: Sep. 19, 2025

Related U.S. Application Data
(60) Provisional application No. 63/696,823, filed on Sep. 19, 2024.

(51) Int. Cl. H02J 50/90; B60L 53/122; B60L 53/38; B60L 53/62; G01B 7/31; H02J 50/10; H02J 50/40

(52) U.S. Cl. CPC H02J 50/90; B60L 53/122; B60L 53/38; B60L 53/62; G01B 7/31; H02J 50/10; H02J 50/40

(57) ABSTRACT

A method of correcting misalignment between two or more transmitter coils embedded in a roadway and two or more receiver coils in a vehicle includes measuring current or voltage in two or more receiver coils when energized by two or more transmitter coils based on electromagnetic coupling between the two or more transmitter coils and the two or more receiver coils, sampling the measured current or voltage, determining magnitude and phase of the sampled current or voltage, using symmetrical component analysis to determine positive and negative sequence components, determining the two or more receiver coils misalignment with respect to the two or more transmitter coils based on the determined positive and negative sequence components, and providing position correction signals or instructions for the two or more receiver coils based on the determined misalignment.

### CROSS-REFERENCE TO RELATED APPLICATIONS

The present non-provisional patent application is related to and claims the priority benefit of U.S. Provisional Patent Application Ser. 63/696,823 filed Sep. 19, 2024, the contents of which are hereby incorporated by reference in its entirety into the present disclosure.

### STATEMENT REGARDING GOVERNMENT FUNDING

This invention was made with government support under 1941524 awarded by the National Science Foundation. The government has certain rights in the invention.

### TECHNICAL FIELD

This disclosure relates to electric vehicles and, in particular, to electric vehicle power systems.

### BACKGROUND

This section introduces aspects that may help facilitate a better understanding of the disclosure. Accordingly, these statements are to be read in this light and are not to be understood as admissions about what is or is not prior art.

Electric vehicles are becoming ubiquitous in the vehicular transportation regime, whether for transporting humans or cargo. However, the charging infrastructure is lagging. In particular, while wired charging stations are continuously added, these wired charging stations are few and far between to accommodate the growing demand for electric vehicles. In concert with adding new wired charging stations, there has been an effort to incorporate dynamic wireless power transfer (DWPT) coils into roadways.

DWPT systems are being considered as a means to provide the power to move, operate, and maintain or increase the state-of-charge of batteries in electric vehicles. DWPT systems utilize transmitter (tx) coils embedded within the roadway to establish time-changing magnetic fields above the road surface. These time-changing magnetic fields induce a voltage in receiver (rx) coils that are incorporated in an underside compartment of an electric vehicle as the vehicle passes over an energized transmitter. The induced voltage is then used to provide power to vehicle subsystems, including propulsion and energy storage (battery).

However, many challenges remain in facilitating DWPT coils in a roadway. One such challenge is that performance is sensitive to the location of the individual phase windings relative to the base roadway layer. Maintaining a desired tolerance becomes challenging given road construction variables, where roadway material is poured over the tx.

These challenges will undoubtedly result in misalignment between tx and rx coils. The cots are designed to tolerate some amount of misalignment; however, within or beyond that level of misalignment, it is vital to understand the effect of misalignment in charging the electric vehicle.

Therefore, there is a need for a method that can predict the negative impact of misalignment in tx coils embedded in pavements and rx coils disposed at the underside compartment of electric vehicles.

### SUMMARY

A method of correcting misalignment between two or more transmitter coils embedded in a roadway and two or more receiver coils in a vehicle is disclosed. The method includes measuring current or voltage in two or more receiver coils when energized by two or more transmitter coils based on electromagnetic coupling between the two or more transmitter coils and the two or more receiver coils, sampling the measured current or voltage, determining magnitude and phase of the sampled current or voltage, using symmetrical component analysis to determine positive and negative sequence components, determining the two or more receiver coils misalignment with respect to the two or more transmitter coils based on the determined positive and negative sequence components, and providing position correction signals or instructions for the two or more receiver coils based on the determined misalignment.

A vehicular charging system is also disclosed. The system includes two or more transmitter coils provided in a roadway, two or more receiver coils provided in a vehicle, such that when the two or more transmitter coils are energized, the two or more receiver coils are energized based on electromagnetic coupling, and a measurement system. The measurement system includes a processor executing software residing on non-transient memory. The processor is configured to measure current or voltage in two or more receiver coils when energized by two or more transmitter coils, sample the measured current or voltage, determine magnitude and phase of the sampled current or voltage, determine positive and negative sequence components based on symmetrical component analysis of the determined magnitude and phase of the sampled current or voltage, determine the two or more receiver coils misalignment with respect to the two or more transmitter coils based on the determined positive and negative sequence components, and provide corrective signals or instructions to correct the determined misalignment.

### BRIEF DESCRIPTION OF DRAWINGS

FIG. 1 is a schematic of transmitter (tx) coils and receiver (rx) coils in relationship to one another, which illustrates a first example of a transverse moving flux topology.

FIG. 2 is a schematic of an example of an optimized coil cross-section for a 50-kW experimental prototype.

FIG. 3 is a photograph of a 50-kW laboratory prototype test setup.

FIGS. 4a and 4b are basic schematics that depict a balanced and an example unbalanced system (FIG. 4a) and the application of the symmetrical components (positive, negative and zero components), FIG. 4b.

FIG. 4c is a symmetrical component sequence T-equivalent model of a generic 3-phase tx/rx system.

FIG. 5a is a block diagram which shows how the method of the present disclosure determines misalignment between tx and rx coils and how this determined misalignment information is used to minimize said misalignment by utilizing a vehicle lane assist system to modify position of the vehicle with respect to the tx coils.

FIG. 5b is a graph of current in amperes vs. time in seconds showing measured rx current for two phases.

FIGS. 6 and 7 are each plots of rectifier output power in kW vs. misalignment in cm, which show the simulated (FIG. 6) and measured (FIG. 7) rx-side average output power and its ripple versus misalignment.

FIG. 8 is a plot of simulated current amplitude in Amperes vs. misalignment in cm for all three phases, which are nearly identical at full alignment, implying a balanced system.

FIG. 9 is a graph of measured current amplitude in amperes vs. misalignment in cm.

FIGS. 10a and 10b are graphs of positive- and negative-sequence amplitude in amperes vs. displacement in cm (FIG. 10a) and phase in degrees vs. displacement in cm (FIG. 10b), respectively.

FIGS. 11a and 11b are graphs of amplitude ratio of positive and negative components of the symmetrical components vs. displacement in cm (FIG. 11a) and phase difference in degrees of positive and negative components of the symmetrical components vs. displacement in cm (FIG. 11b), respectively, which show the amplitude and phase of the positive and negative sequence components of the rx currents, respectively.

FIG. 11c provides two graphs of amplitude and phase vs. misalignment in cm for both simulated and measured values.

FIG. 12 is a schematic of blocks which illustrates an example of a system 100, according to the present disclosure.

### DETAILED DESCRIPTION

For the purpose of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach is presented herein to assist in predicting negative impact of misalignment between transmitter (tx) coils embedded in pavements and receiver (rx) coils disposed at the underside compartment of electric vehicles. Towards this end, modeling techniques are discussed herein that are used to predict the performance of a 50-kW three-phase dynamic wireless power transfer system with magnetic poles across the road over a range of tx-rx alignments. Specifically, a symmetrical-component-based model of the three-phase transmitter-receiver is detailed and validated. Strong agreement is demonstrated between the predicted and measured power and winding currents. Subsequently, the predicted system behavior is analyzed and exploited to establish a straightforward receiver misalignment estimation/detection scheme that leverages the ratio and phase of the sequence components.

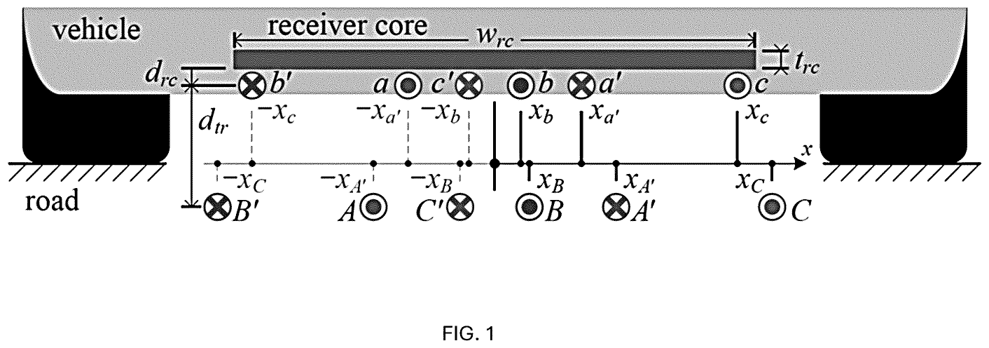

In general, significant environmental benefits lie in deploying dynamic wireless power transfer (DWPT) technology for heavy-duty vehicle (HDV) fleets. However, it is difficult to accommodate the power needs of HDVs with single-phase topologies; therefore, three-phase solutions are of interest. Recently, the arrangement of a three-phase transmitter (tx) coils and receiver (rx) coils was proposed for such applications. The coil sides of each of the phase windings are judiciously placed (locations are labeled with x's in FIG. 1) to minimize power fluctuation and poor current/voltage sharing among phases that had been observed in such planar topologies.

A system and method of mutual coupling between a three-phase transmitter coil setup in the roadway and the three-phase receiver coil setup in a vehicle is disclosed herein such that misalignment between a transmitter and receiver coil may be identified and corrected. Modeling techniques were applied to predict the performance of a 50-kW three-phase dynamic wireless power transfer system with magnetic poles across the road over a range of tx-rx alignments. Specifically, a symmetrical-component-based model of the three-phase transmitter-receiver is utilized, detailed, and validated in the present disclosure. Strong agreements were identified between the predicted and measured power and winding currents. Subsequently, the predicted system behavior was analyzed and exploited to establish a straightforward receiver misalignment estimation/detection system that leverages the ratio and phase of the sequence components. This identified misalignment can be used to correct position of the vehicle to thereby align the receiver (rx) coil disposed in the vehicle with the transmitter (tx) coil in the pavement.

Referring to FIG. 1, which is a schematic of a tx and rx coils in relationship to one another, illustrates a first example of a transverse moving flux topology. Each circle denotes a conductor wire as part of a corresponding coil, with a dot within a circle representing current defined as positive coming out of the page and a cross within a circle denoting current defined as positive going into the page. It should be noted that the aforementioned directionality is only a convention based on the assumption of what positive current signifies. As seen in this topology the coils in the roadway need not be disposed in the same manner as the coils in the vehicle. The dimensions between the coils and the receiver core as well as the dimensions between the conductors of the coil and a centerline and each other are shown in the form of variables.

In FIG. 1, the transmitter (tx) and receiver (rx) coils are mirror images of each other with respect to a central vertical line. Therefore, if the dot side of coil C (i.e., the farthest coil (coil C)) is x_{c} away from the centerline, then cross side of coil B (i.e., the nearest coil (coil B)) is also x_{c} away from the centerline on the opposite side of the centerline. Similarly, if the dot side of Coil A is −x_{A}⋅away from one side of the centerline, the cross side of coil A is the same x_{A}⋅away from the centerline on the opposite side of the centerline. Finally, if the dot side of coil B is x_{B} away from the centerline on one side of the centerline, then the cross side of coil C is also x_{B} away from the centerline on opposite side of the centerline. The same mirror image configuration also holds true for receiver coils.

It should be noted that in FIG. 1 the transmitter coils appear to be disposed in a uniform fashion. That is, the spacing between the coils are about the same. However, the seeming uniformity shown is only to emphasize the lack of uniformity for the receiver side. In practice, the transmitter coils and the receiver coils need not be uniformly disposed with respect to other coils. That is, the transmitter coils can be disposed in a non-uniform manner with respect to other transmit coils and also with respect to the receiver coils.

A 50-kW DWPT hardware system was used to validate the sequence component analysis-based approach of modeling the three-phase transmitter-receiver system by analyzing the predicted and measured behavior. Key results indicate that the design meets the target power level and that the model predicts the power and currents of the system with good accuracy under all alignment conditions. Analysis of system behavior also shows a correlation between receiver displacement and sequence components. This correlation is utilized herein to derive a system and method for estimating misalignment between the transmitter coil and a receiver coil. In some examples, a single-valued function that can be executed in the form of a lookup table, which outputs the extent as well as the direction of receiver displacement with respect to the transmitter. As discussed above, this estimated misalignment can be used within a vehicle guidance system to maintain receiver-transmitter alignment.

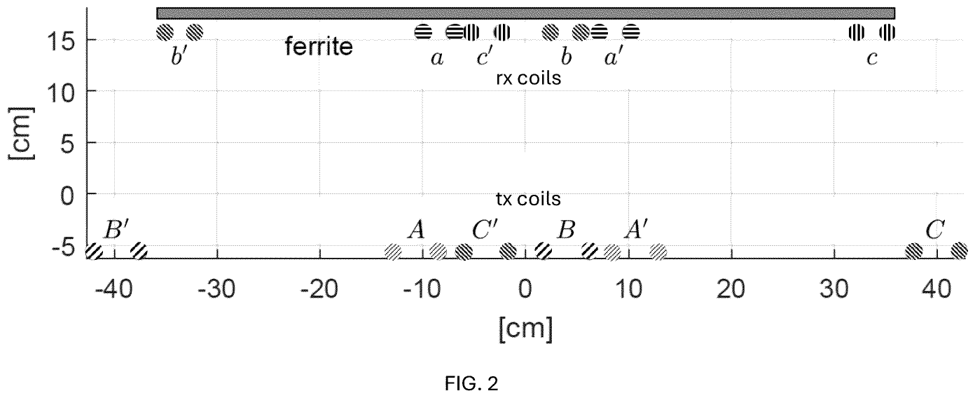

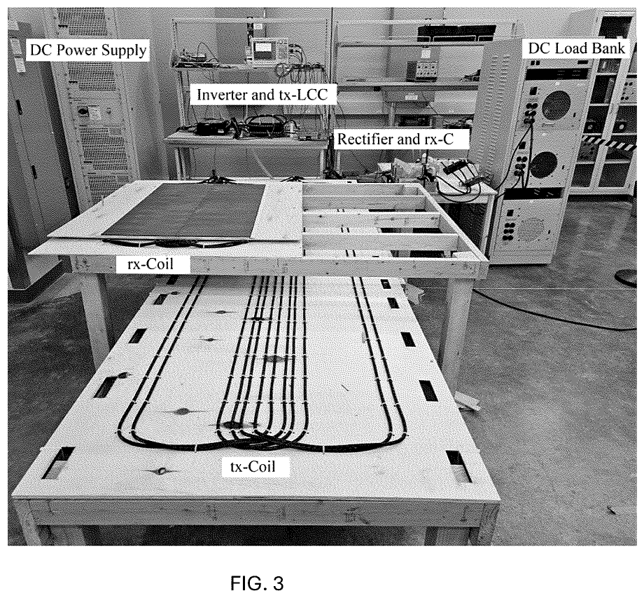

Referring to FIG. 2, a schematic of an example of an optimized coil cross-section for 50-kW experimental prototype is shown. It should be noted that the dimensions provided are for example purposes only and no limitations are intended thereby. FIG. 3 illustrates a 50-kW laboratory prototype test setup.

Referring to FIGS. 2 and 3, the tx and rx self- and mutual inductances form the basis of the alignment detection model, which are dependent on the receiver coil location relative to the transmitter coil locations. Due to differences in coil width and relative displacement, both tx and rx coils may become imbalanced. A classical approach to analyze imbalance in 3-phase ac circuits is to use symmetrical components (SC) in which phase voltages, currents, and flux linkages are transformed to positive, negative, and zero sequence values. Using such an approach and referring the rx-side quantities to the tx side using a turns ratio factor, a positive-sequence model of the flux linkage versus current can be expressed as:

$$[ \begin{matrix}{Λ}_{t}^{1} \\ {Λ}_{r}^{1 ′}\end{matrix} ] = [ \begin{matrix}{L}_{T} & {M}^{′} \\ {M}^{′} & {L}_{T}\end{matrix} ] [ \begin{matrix}{I}_{t}^{1} \\ {I}_{r}^{1 ′}\end{matrix} ] + [ \begin{matrix}{L}_{t}^{12} & {M}_{tr}^{12} \\ {M}_{tr}^{12 ′} & {L}_{r}^{12 ′}\end{matrix} ] [ \begin{matrix}{I}_{t}^{2} \\ {I}_{r}^{2 ′}\end{matrix} ]$$

The equation above represents the positive-sequence circuit model of the three-phase transmitter-receiver coil pair. The first matrix on the right-hand side captures the self-inductances and the mutual coupling between the transmitter and receiver in the positive-sequence circuit. The second matrix accounts for the cross-coupling between the positive- and negative-sequence circuits of the transmitter and receiver coils. The negative sequence equations are identical in form, except that positive and negative sequence variables exchange places, and all elements in the second matrix are conjugated.

In the equation,

$${Λ}_{x}^{i}$$

represents flux linkage phasor of coil x in sequence-i circuit.

$${I}_{x}^{i}$$

represents current phasor or con x in sequence-i circuit.
{x, y}∈{t, r} denote the tx or rx coil.
{i, j}∈{1, 2} are the sequence indices. 1=positive sequence and 2=negative sequence.

$${M}_{x y}^{i j}$$

represents the mutual inductance between coil x and y, capturing the coupling between their i- and j-sequence circuits. Here

$$M {=}^{Δ} Re \{ {M}_{tr}^{11} \} = Re \{ {M}_{tr}^{22} \} .$$

A quantity F′ is called a referred quantity and here it is referred to the tx-side using turns-ratio, defined as,

$$n {=}^{Δ} \sqrt{{L}_{R} / {L}_{T}}$$

For fluxes (A) and mutual inductances (M),

$${F}^{′} {=}^{Δ} F / n .$$

For currents (I),

$${F}^{′} {=}^{Δ} nF$$

For inductances (L),

$${F}^{′} {=}^{Δ} F / {n}^{2} ,$$

$${L}_{x}^{i j}$$

is the inductance of coil x, representing its sequence self-inductance when i=j or capturing coupling between its i- and j-sequence circuits otherwise. Here

$${L}_{T} {=}^{Δ} {L}_{t}^{11} = {L}_{t}^{22} and {L}_{R} {=}^{Δ} {L}_{r}^{11} = {L}_{r}^{22}$$

are real, with

$${L}_{R}^{′} = {L}_{T} .$$

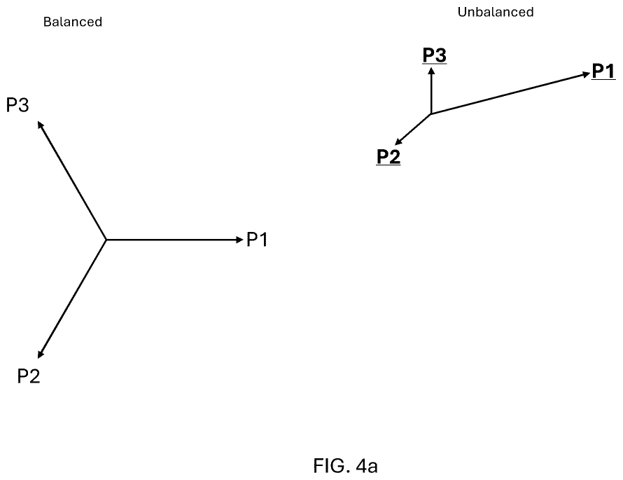

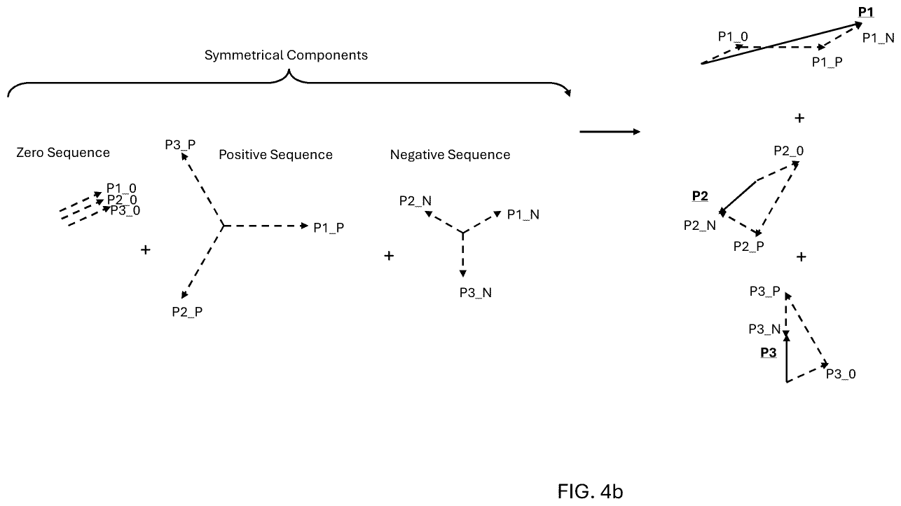

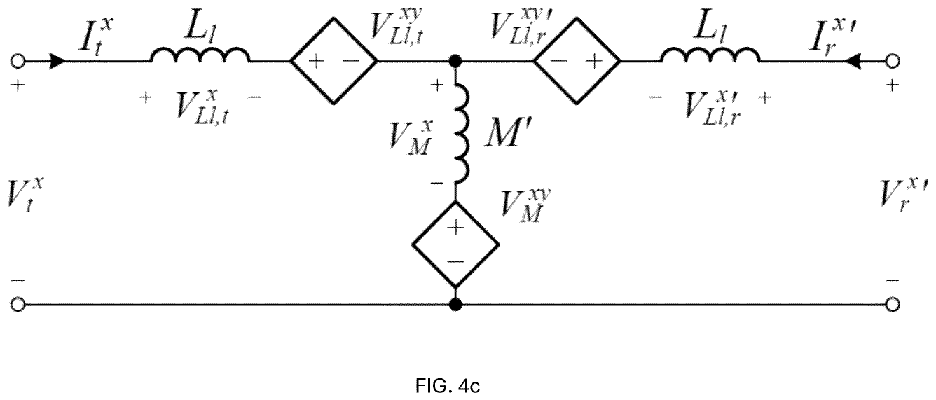

Referring to FIGS. 4a and 4b, basic schematics are shown to depict a balanced and an example unbalanced system and the application of the symmetrical components (positive, negative and zero components). FIG. 4c illustrates an SC sequence T-equivalent model of a generic 3-phase tx/rx system. The negative-sequence equations are identical in form, except that positive- and negative-sequence variables exchange places and all elements in the second matrix are conjugated. From these relationships, the T-equivalent of the tx-rx system shown in FIG. 4c can be derived. Comparing (1) to FIG. 4c, it can be observed that the coupling between like sequence terms (e.g. 1-1) are represented using impedance, while those between sequences (e.g. 1-2) are represented using dependent voltage sources.

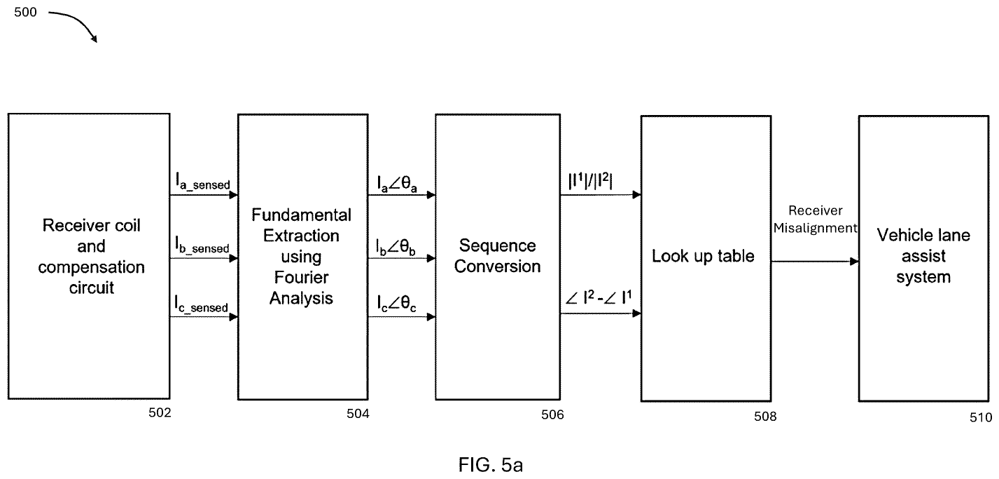

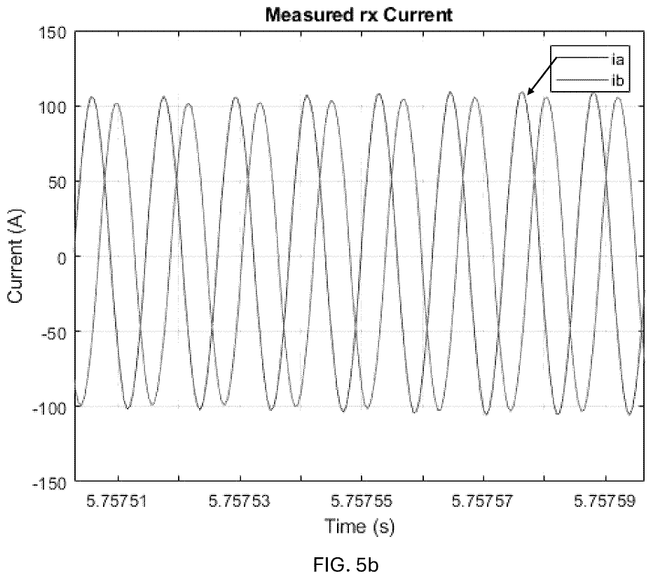

Referring to FIG. 5a, a block diagram is provided which shows how the method of the present disclosure determines misalignment between tx and rx coils and how this determined misalignment information is used to minimize said misalignment by utilizing a vehicle lane assist system to modify position of the vehicle with respect to the tx coils. The block diagram includes several major blocks, including a receiver coil and compensation circuit block 502 which provides sensed current for three phases to a fundamental extraction block 504 that uses a frequency analysis toolset, e.g., a Fourier Analysis tool, that receives the sensed current for all three phases and generates phase and magnitude for each of current of each phase. The generated phase and magnitude for each current is provided to a sequence conversion block 506 which receives the phase and magnitude values for each current of each phase and generates sequence parameters which are then used by the method 500 to lookup misalignment values (i.e., rx coil positions) in a lookup table 508. Once the misalignment values are known, these values are communicated to a lane assist system 510 that can correct vehicle position with respect to the tx coil positions to maximize charging of the vehicle. Each of these blocks are discussed below.

The system of the present disclosure which includes tx coils embedded in pavement of a roadway and rx coils disposed in an underside compartment of a vehicle includes a three-phase receiver coil connected to a compensation network followed by an AC-DC converter all within the receiver coil and compensation circuit block 502. The compensation network is used to tune the coil to a particular resonant frequency by adjusting lumped parameters such as inductances it also compensates for the leakage inductance of the coil. The type of compensation network used determines the nature of its output which can either be a current source or voltage source, FIG. 5a shows current but both current or voltage outputs are within the ambit of the present disclosure. The AC-DC converter is used to control the output power to a load.

Starting from the left of FIG. 5a, 3-phase (i.e., a-b-c) voltages or currents at the receiver (vehicle) side are measured, i.e., I_{a-sensed}, I_{b-sensed}, and I_{c-sensed}; Or V_{a-sensed}, V_{b-sensed}, and V_{c-sensed}. According to one embodiment currents are used. One could also use the receiver line-neutral or line-line voltages, voltages or currents within the compensation circuit between the receiver and ac-dc converter, or at points within the ac-dc converter. The fundamental component of the receiver quantities is typically at a relatively high frequency (e.g., 85 kHz); therefore, measurements must be sampled at a frequency which allows an accurate decomposition of the frequency content of the waveforms. At a minimum, the sampling frequency must meet the Nyquist criterion (i.e., at least twice of the fundamental) but can be as high as 10 times the fundamental frequency to achieve better measurement accuracy. The fundamental frequency is determined by the excitation frequency of the transmitter coil.

Current can be sensed using Rogowski coils, Hall-effect current sensors, or shunt resistors, as is known to a person having ordinary skill in the art. In the method of present disclosure, Rogowski coils were used, as all the signals to be sensed are AC-type signals. The simplest method for measuring voltages will be to use Hall-effect sensors. Referring to FIG. 5b, a graph of current in amperes vs. time in seconds is showing measured rx current for two phases. Since the receiver is wye-connected, the c-phase current is calculated using the other two, as is known to a person having ordinary skill in the art. Therefore, only two current/voltage sensors are required.

The next block in the method 500 is the fundamental extraction block 504 which uses a frequency analysis toolset, e.g., a Fourier Analysis tool. To highlight, measured receiver winding values (in this case currents but could be voltage) are measured and the fundamental component extracted digitally using a Fourier Series decomposition. The sequence components are then obtained from the extracted fundamentals and are input to a lookup table that maps the amplitude ratio and phase difference to receiver position. A more detailed example of the misalignment detection logic follows.

The magnitude and phase angle of the fundamental component of each 3-phase time-domain signals are obtained using one of a plurality of techniques, analog or digital, including continuous- or discrete-time Fourier transforms. In various experiments, these components were extracted by calculating the components of the Fourier series of the waveforms and obtained phasor expressions. This is an important step in the process as it removes any DC bias error and higher-order harmonics present in the measurements.

In practice, the transmitter pads are energized with AC currents at a fixed fundamental frequency (F_{fund}), typically between 80-90 kHz. This fundamental component is the primary contributor to power transfer on the receiver side and is therefore the frequency of interest. Since the voltage and current waveforms on the receiver side may contain harmonics, Fourier analysis is employed to isolate the magnitude and phase of the F_{fund} components.

A Fourier transform is applied to a window of sampled voltage and current data from the sensors, and the Fourier coefficients (an, bn) corresponding to F_{fund} are extracted. These coefficients are then used to compute the magnitude and phase of the fundamental components, as is known to a person having ordinary skill in the art.

There are multiple methods for calculating the Fourier coefficients. According to one embodiment of the present disclosure, if the implementation will be on a microcontroller or a DSP, the Fast Fourier Transform (FFT) is one of the suitable techniques that can be employed. The following provides steps, according to one embodiment:
i) Sample the current/voltage signals.
ii) Accumulate the sampled data to be analyzed.
iii) Use, e.g., Hanning/Hamming window functions to help reduce spectral leakage (optional step).
iv) Employ FFT to the given sample window.
   a) For N samples of signal x[k],

$$X [ m ] = {\sum }_{k = 0}^{N - 1} x [ k ] {e}^{- j 2 π mk / N}$$

b) The exponential can be split into real and imaginary parts:

$${e}^{j θ} = cos ( θ ) + j sin ( θ )$$

c) The Fourier coefficients can then then be calculated as:

$${a}_{1} = \frac{2}{N} Re \{ X [ {m}_{0} ] \} , {b}_{1} = - \frac{2}{N} Im \{ X [ {m}_{0} ] \}$$

where m₀=round (F_{fund}·N/fₛ) and fₛ is the sampling frequency.
v) Using the Fourier coefficients, the magnitude and phase are respectively calculated as:

$$\vert {X}_{1} \vert = \sqrt{{a}_{1}^{2} + {b}_{1}^{2}} , {ϕ}_{1} = arc tan 2 ( - {b}_{1} , {a}_{1} ) .$$

vi) For sequence (positive, negative and zero) analysis, the FFT results are used to obtain the current/voltage phasors:

$${X}_{1}^{i} = \frac{\vert {x}_{1}^{i} \vert}{\sqrt{2}} {e}^{j {ϕ}_{1}^{i}}$$

where X is the voltage/current phasor and i∈{a, b, c} are the phases of the receiver coil. It should be noted that since only the fundamental frequency component is of interest, a more efficient algorithm, such as the Goertzel algorithm, known to a person having ordinary skill in the art, can be implemented. This algorithm significantly reduces the number of computations and is well-suited for real-time applications on DSPs and microcontrollers.

Other techniques for calculating the phase and amplitude of signals may include:
i) Decoupled double synchronous phase-locked loops (PLLs): These can be used to extract positive and negative sequence amplitudes and phases in the d-q domain.
ii) Analog signal-processing operations: These may involve signal multiplication, filtering, and phase-locked-loops (PLLs) implemented in analog circuitry.

The next block is the sequence conversion 506 in the method 500. From the magnitude and phase-angle extraction, the magnitude and phase of the positive- and negative-sequence of the fundamental component of the 3-phase waveforms are obtained using the Fortescue transformation. That is, after calculating the a, b and c phasors using one of the techniques mentioned above, Fortescue's transformation is used to calculate the sequence components of the imbalanced a, b, c phasor set. It should be noted that while the Fortescue's transformation is based on three phases, different transformations can be used for two phases. The Fortescue's transformation is mathematically expressed as:

$${F}^{012} = {A}^{- 1} {F}^{a b c}$$

$$where ,$$

$${A}^{- 1} = \frac{1}{3} [ \begin{matrix}1 & 1 & 1 \\ 1 & a & {a}^{2} \\ 1 & {a}^{2} & a\end{matrix} ]$$

F⁰¹² are the sequence components (zero-, positive- and negative-sequence components, respectively), F^{abc} are the three-phase (a-b-c) phasors, and

$$a = {e}^{i \frac{2 π}{3}} .$$

These parameters can be applied to current or voltage. For example, in case of current, the following equations govern:

$$[ \begin{matrix}{I}_{0} \\ {I}_{1} \\ {I}_{2}\end{matrix} ] = \frac{1}{3} [ \begin{matrix}1 & 1 & 1 \\ 1 & a & {a}^{2} \\ 1 & {a}^{2} & a\end{matrix} ] [ \begin{matrix}{I}_{a} \\ {I}_{b} \\ {I}_{c}\end{matrix} ]$$

which can be written as three equations:

$${I}_{0} = \frac{1}{3} ( {I}_{a} + {I}_{b} + {I}_{c} )$$

$${I}_{1} = \frac{1}{3} ( {I}_{a} + {aI}_{b} + {a}^{2} {I}_{c} )$$

$${I}_{2} = \frac{1}{3} ( {I}_{a} + {a}^{2} {I}_{b} + {aI}_{c} )$$

Since the receiver-side coil is wye-connected with its neutral point floating, this configuration eliminates any zero-sequence current in the system.

These relationships can be simplified by:

$${I}_{p} = {AI}_{s}$$

Where Iₚ is the current phase vector and Iₛ is the sequence currents. Iₛ can be determined based on:

$${I}_{s} = {A}^{- 1} {I}_{P}$$

The phase currents can then be written as:

$${I}_{a} = {I}_{0} + {I}_{1} + {I}_{2}$$

$${I}_{b} = {I}_{0} + {a}^{2} {I}_{1} + {aI}_{2}$$

$${I}_{c} = {I}_{0} + {aI}_{1} + {a}^{2} {I}_{2}$$

In a Y-connected 3-phase system, there is a neural current Iₙ which is the sum of the phase currents Iₐ+I_{b}+I_{c}. Therefore, Iₙ is 3I₀. The sequence conversion block 506, therefore, provides magnitude of positive sequence and negative sequence (I₁ and I₂) in the form of magnitude (i.e., |I₁|/|I₂|) and phase of positive and negative sequence (i.e., phase I₂−phase I₁) to the lookup table block 508.

The next block is the lookup table block 508. It is observed that the ratio of the positive/negative sequence amplitudes together with the phase-difference between the positive and negative sequence angles provides the ability to determine the lateral displacement distance and direction (left/right from center). In theory, mathematical functions could be used to establish closed-form relationships. For simplicity, measured data may be used to create a lookup table in which the inputs to the lookup table are the ratio of the positive/negative-sequence amplitudes and the difference between the positive- and negative-sequence phase angles, and the output is the receiver (vehicle) lateral position with respect to a defined receiver zero position at which maximum power transfer is achieved (normally, when the receiver is perfectly centered on top of the transmitter). The lookup table provides the receiver coils misalignment as compared to the transmitter coils as the receiver coils position.

Once the positive and negative sequence components are obtained, a sequence component ratio is calculated, defined as:

$$ψ {=}^{△} \frac{{I}^{2}}{{I}^{1}}$$

The phase and amplitude of ψ is used in conjunction with a lookup table to calculate the misalignment. Both phase and amplitude plots are used to determine the misalignment.

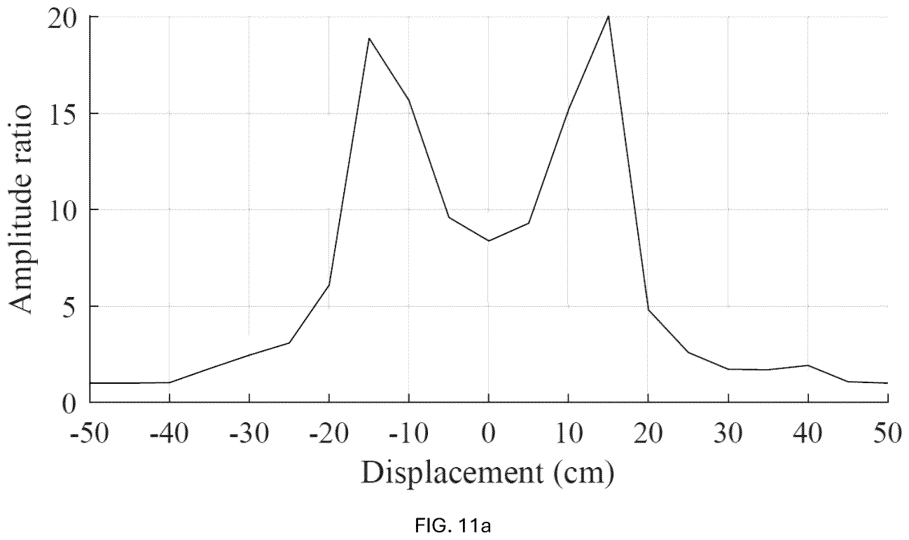

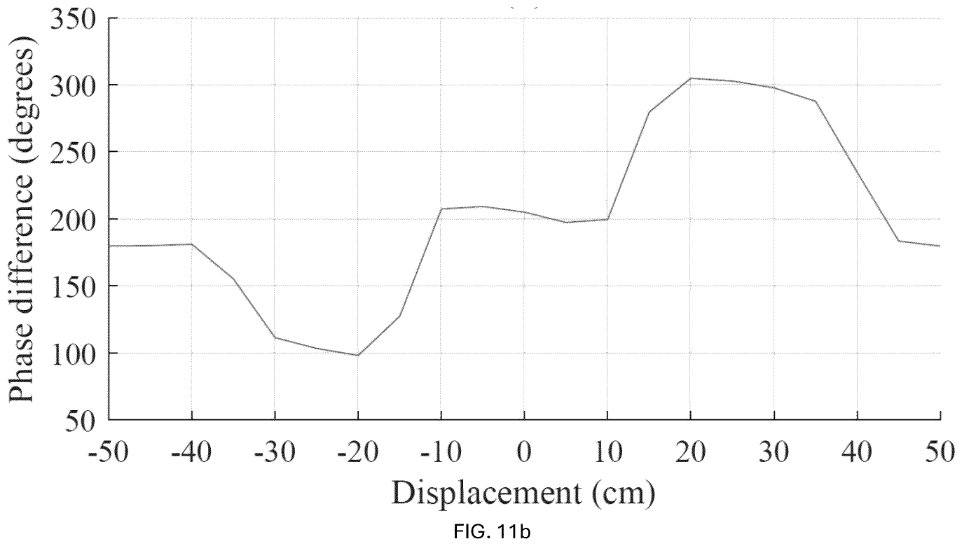

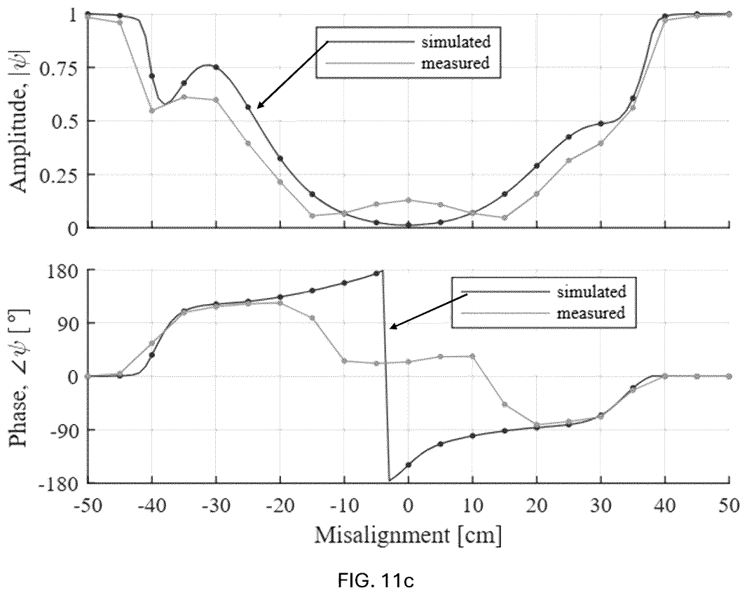

The misalignment can be determined using a lookup table. Referring to FIG. 11c, which provides two graphs of amplitude and phase vs. misalignment in cm for both simulated and measured values, it can be seen from the figure that the amplitude plot assumes an almost symmetric waveform about the center. This information is used to determine the absolute value of misalignment. However, the phase plot assumes an asymmetric waveform about the center and is therefore used to determine the direction of misalignment. Combining these two, both the direction as well as the value of misalignment are estimated.

The misalignment obtained is with respect to the center of the transmitter coil. For example, if the vehicle is misaligned towards the right of the transmitter coil, the estimate can be +10 cm or +20 cm. If it is misaligned towards left, the estimate can be −10 cm or −20 cm. The value will change depending on the degree of misalignment.

As discussed, in the misalignment detection algorithm of the present disclosure, according to one embodiment, and with reference to FIG. 11c, the positive/negative sequence amplitude ratio is used to determine the displacement range; for example, a plot value greater than about 15 represents a displacement band of about ±(10-15) cm. But a given range of values can represent multiple displacement bands; for example, a plot value between about 10-15 can represent the displacement band of either about ±(5-10) cm or about ±(15-20) cm. In such cases, the phase-difference plot is used both as a tiebreaker and also as a way to determine the direction of displacement. The phase difference plot is sufficient to provide complete displacement information, but the use of both the ratio and the phase difference plot increases the granularity of the estimation in the about ±10 cm band. Therefore, a lookup table that incorporates the ratio and the phase-difference plot works as a single-valued function that can be used to provide an estimate of the displacement.

It should be noted that the estimate of lateral misalignment obtained here is independent of the vertical misalignment (i.e., deviation from nominal tx-rx air gap) as well as the receiver power output. This is because w is the ratio of the sequence components, which scale equally with vertical misalignment or power transfer.

The lookup table is determined using either simulation or experiments. In either of the methods, the receiver and transmitter are misaligned at predetermined positions and energized to obtain the receiver currents/voltage data. The data obtained is then used to calculate the positive and negative sequence components, and then to determine the lookup table.

When a simulation-based approach is used, the mutual inductance data obtained from a variety of electromagnetic analysis methods, such as finite element analysis, method of moments, or the boundary element method, can be used. The computed inductance matrix is then fed into a circuit simulation to obtain the voltage/current data.

This test only needs to be performed once for a given tx-rx pair and can therefore be categorized as a type test, referring to a test that is performed once on a representative unit of a product or system to verify that it meets specified design and performance standards. It is not repeated for every unit produced, unlike routine or production tests.

It should be noted that other techniques can also be used instead of a lookup table, e.g., using a curve fit approach to generate a formulaic approach, where the misalignment is calculated based on ψ rather than looking up the misalignment value in a table.

The last block is the vehicle lane assist system 510 which receives the receiver coil position and then it is used as feedback in a vehicle lane-assist logic. The lane-assist logic can output feedback in many forms. For example, it can be a simple display or audio cue that prompts the driver to steer the vehicle in a particular direction, or it can be employed as an error input to the closed-loop steering control of an autonomous vehicle driving system.

It should be appreciated that the methodology discussed herein can be extended to other polyphase systems (e.g., two-phase systems), in which case the transformations discussed above would be modified, accordingly.

Hardware studies were performed to verify the expected performance of a 50-kW DWPT system using the modeling approach highlighted in the previous section. The experimental system (shown in FIG. 3) includes a two-level, 3-phase SiC inverter, operating with 6-step switching, powering the LCC compensated wye-connected tx coil. The series compensated rx coil is connected to a 3-phase diode rectifier feeding a resistive load bank. All compensation circuit component values were selected from an analysis of the positive-sequence circuit.

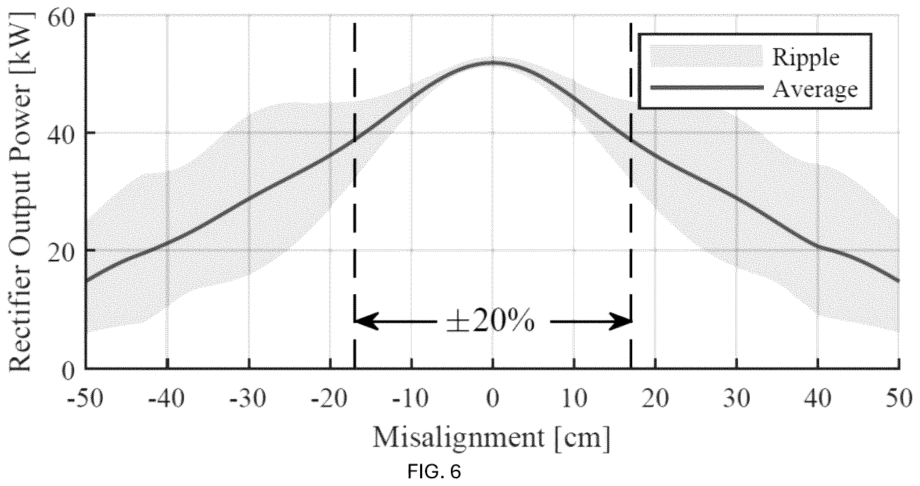

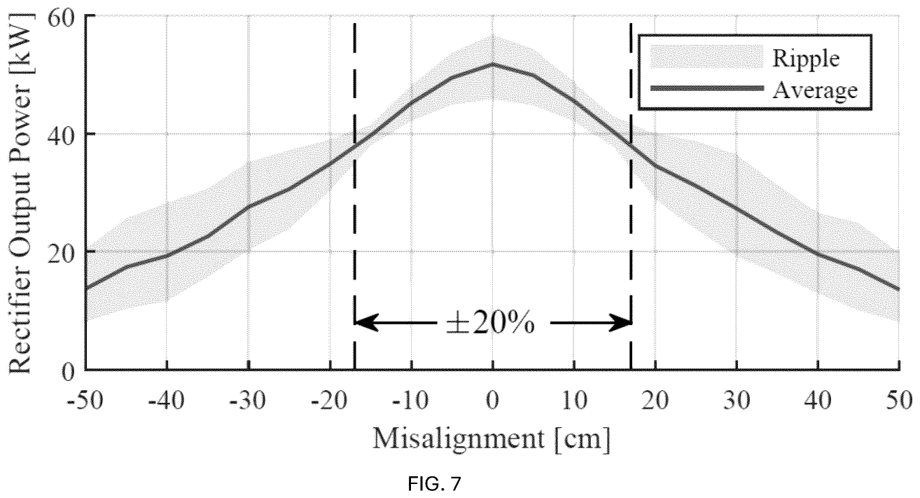

The misalignment performance of the full system shown in FIG. 3 was first predicted using time-domain simulations. Key areas of focus are the impact of displacement on average power, power ripple, and the respective imbalance of the tx/rx currents. The system was then operated in the laboratory under the same displacements to obtain measured performance. FIG. 6 and FIG. 7, respectively, are each plots of rectifier output power in kW vs. misalignment in cm, which show the simulated and measured rx-side average output power and its ripple versus misalignment. From the figures, one can observe that the average power is well predicted, that it meets its desired 50 kW at full alignment and that the ripple at full alignment is relatively small. There are some differences in the level of the power ripple that are attributed to nonidealities, including end-turn and lead inductances and winding and semiconductor resistances that were not included in the simulation.

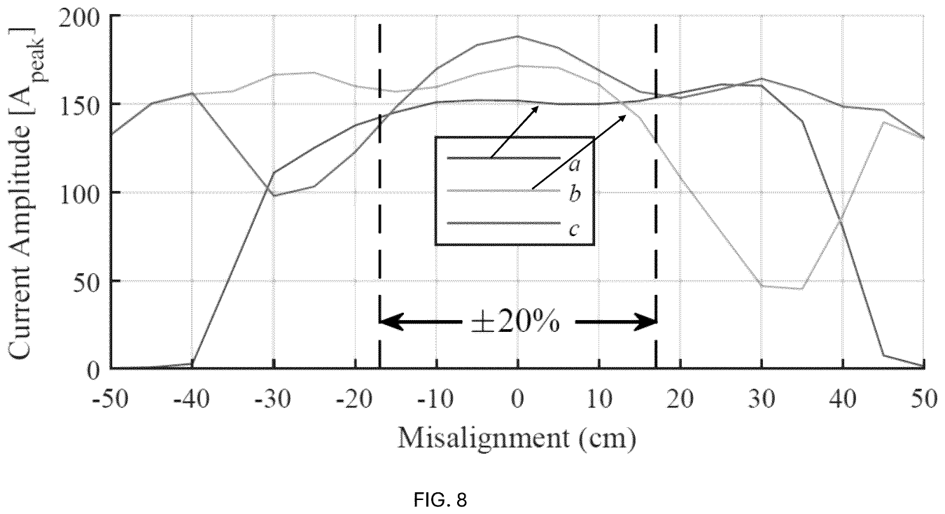

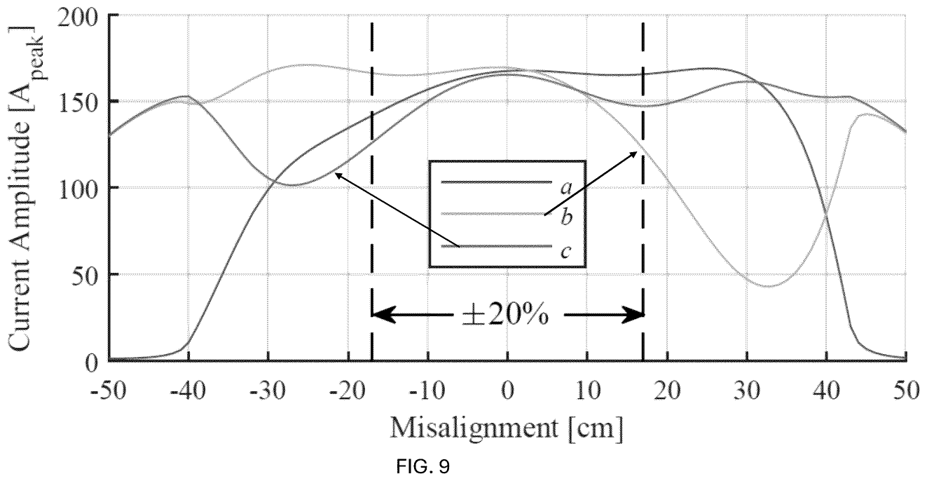

Simulated current amplitudes shown in FIG. 8, which is a plot of simulated current amplitude in Amperes vs. misalignment in cm for all three phases, are nearly identical at full alignment, implying a balanced system. However, as the receiver undergoes misalignment, the imbalance between phase windings increases. Interestingly, at severe misalignment (e.g. −40 cm), only the b- and c-phases operate with equal amplitude, and the 3-phase receiver operates as a single-phase double-D receiver. This imbalance translates into the increase in power ripple observed in FIG. 6. A similar behavior is observed in the hardware system shown in FIG. 9, which is a graph of measured current amplitude in amperes vs. misalignment in cm.

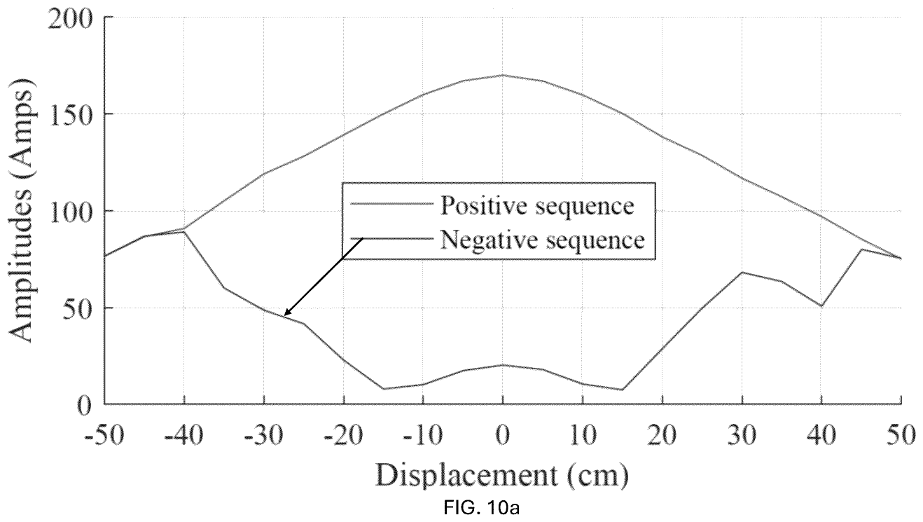

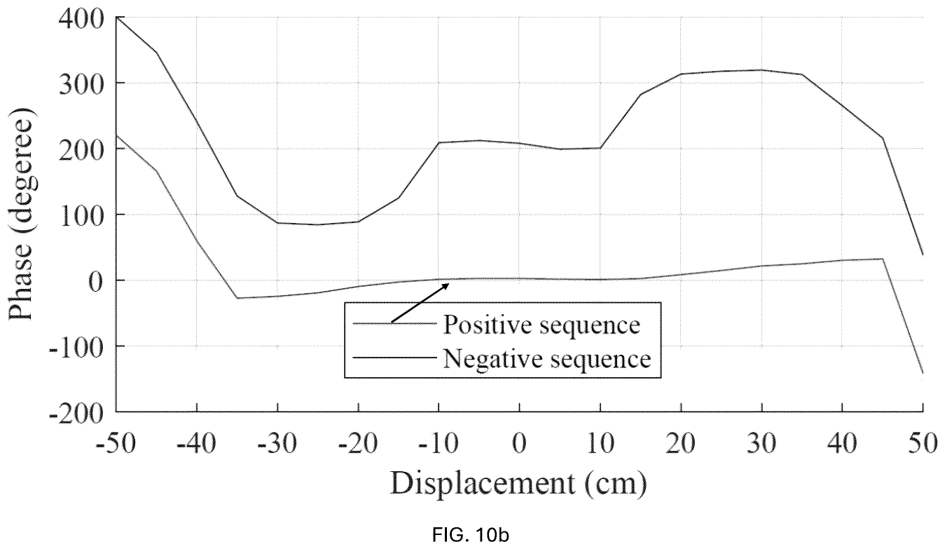

Drawing motivation from the observed current imbalance resulting from receiver displacement, the measured rx currents were studied under the lens of the sequence components. FIGS. 10a and 10b, which are graphs of amplitude in amperes vs. displacement in cm and phase in degrees vs. displacement in cm, respectively; and FIGS. 11a and 11b which are graphs of amplitude ratio of positive and negative components of the symmetrical components vs. displacement in cm and phase difference in degrees of positive and negative components of the symmetrical components vs. displacement in cm, respectively, show the amplitude and phase of the positive and negative sequence components of the rx currents, respectively. From the figures, one can observe that the amplitudes of both are nearly symmetrical about the center (i.e. 0 cm displacement) while the phases are not. Interestingly, the phase of the negative sequence shows a dramatic change in shape that clearly depends on the direction of the lateral displacement. The behaviors observed provide a way to determine the extent and direction of displacement.

The logic illustrated in the drawings may include additional, different, or fewer operations than illustrated. The system may be implemented with additional, different, or fewer components than illustrated.

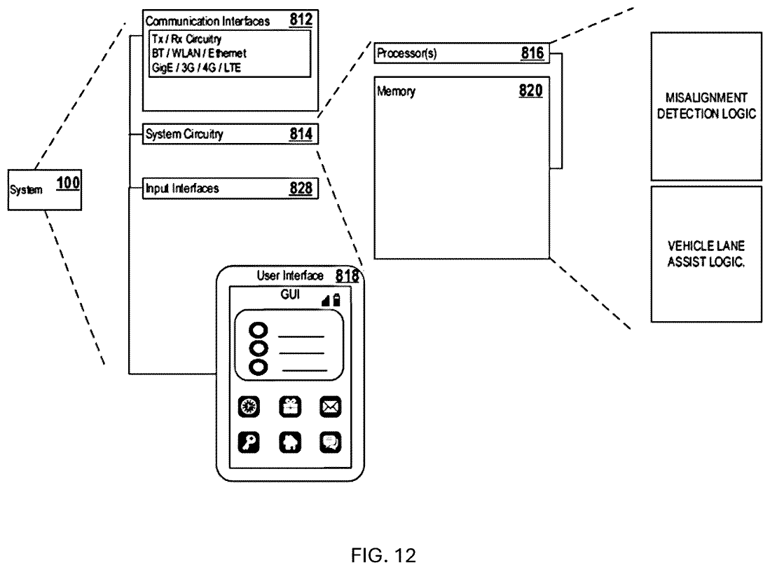

FIG. 12 is a schematic of blocks which illustrates an example of a system 100, according to the present disclosure. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations of the misalignment detection logic, the vehicle lane assist logic, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the misalignment detection logic, the vehicle lane assist logic, and/or the system 100. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the misalignment detection logic, the vehicle lane assist logic, or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

While various embodiments have been described, it will be apparent to those of ordinary skill in the art that many more embodiments and implementations are possible. Accordingly, the embodiments described herein are examples, not the only possible embodiments and implementation.

1. A method of correcting misalignment between two or more transmitter coils embedded in a roadway and two or more receiver coils in a vehicle, comprising:
measuring current or voltage in two or more receiver coils when energized by two or more transmitter coils based on electromagnetic coupling between the two or more transmitter coils and the two or more receiver coils;
sampling the measured current or voltage;
determining magnitude and phase of the sampled current or voltage;
using symmetrical component analysis to determine positive and negative sequence components;
determining the two or more receiver coils misalignment with respect to the two or more transmitter coils based on the determined positive and negative sequence components; and
providing position correction signals or instructions for the two or more receiver coils based on the determined misalignment.

2. The method of claim 1, wherein the two or more transmitter coils include three coils.

3. The method of claim 2, wherein the two or more receiver coils are energized based on three phases, wherein each of the two or more transmitter coils is coupled to a respective phase.

4. The method of claim 3, wherein the energization of the two or more receiver coils represents an unbalanced system based on misalignment between the two or more receiver coils and the two or more transmitter coils and geometry of the two or more receiver coils.

5. The method of claim 1, wherein the step of determining magnitude and phase of the sampled current or voltage is based on a frequency analysis.

6. The method of claim 5, wherein the frequency analysis is a Fourier analysis.

7. The method of claim 3, wherein the symmetrical component analysis includes a positive sequence component (I₁ or V₁), a negative sequence component (I₂ or V₂), and a zero sequence component (I₀ or V₀).

8. The method of claim 7, wherein for current measurements, positive sequence component (I₁), a negative sequence component (I₂), and a zero sequence component (I₀) are expressed based on:
$${I}_{0} = \frac{1}{3} ( {I}_{a} + {I}_{b} + {I}_{c} )$$
$${I}_{1} = \frac{1}{3} ( {I}_{a} + {aI}_{b} + {a}^{2} {I}_{c} )$$
$${I}_{2} = \frac{1}{3} ( {I}_{a} + {a}^{2} {I}_{b} + {aI}_{c} )$$
wherein Iₐ represents the measured current for a first phase of the three phases,
I_{b} represents the measured current for a second phase of the three phases,
I_{c} represents the measured current for a third phase of the three phases, and
a is
$${e}^{i \frac{2 π}{3}} .$$

9. The method of claim 7, wherein for voltage measurements, positive sequence component (V₁), a negative sequence component (V₂), and a zero sequence component (V₀) are expressed based on:
$${V}_{0} = \frac{1}{3} ( {V}_{a} + {V}_{b} + {V}_{c} )$$
$${V}_{1} = \frac{1}{3} ( {V}_{a} + {aV}_{b} + {a}^{2} {V}_{c} )$$
$${V}_{2} = \frac{1}{3} ( {V}_{a} + {a}^{2} {V}_{b} + {aV}_{c} )$$
wherein Vₐ represents the measured voltage for a first phase of the three phases,
V_{b} represents the measured voltage for a second phase of the three phases,
V_{c} represents the measured voltage for a third phase of the three phases, and
a is
$${e}^{i \frac{2 π}{3}} .$$

10. The method of claim 1, wherein the two or more transmitter coils include two coils and the two or more receiver coils are energized based on two phases, wherein each of the two or more transmitter coils is coupled to a respective phase.

11. A vehicular charging system, comprising:
two or more transmitter coils provided in a roadway;
two or more receiver coils provided in a vehicle, such that when the two or more transmitter coils are energized, the two or more receiver coils are energized based on electromagnetic coupling; and
a measurement system, including a processor executing software residing on non-transient memory, the processor configured to:
measure current or voltage in two or more receiver coils when energized by two or more transmitter coils;
sample the measured current or voltage;
determine magnitude and phase of the sampled current or voltage;
determine positive and negative sequence components based on symmetrical component analysis of the determined magnitude and phase of the sampled current or voltage;
determine the two or more receiver coils misalignment with respect to the two or more transmitter coils based on the determined positive and negative sequence components; and
provide corrective signals or instructions to correct the determined misalignment.

12. The vehicular charging system of claim 11, wherein the two or more transmitter coils include three coils.

13. The vehicular charging system of claim 12, wherein the two or more receiver coils are energized based on three phases, wherein each of the two or more transmitter coils is coupled to a respective phase.

14. The vehicular charging system of claim 13, wherein the energization of the two or more receiver coils represents an unbalanced system based on misalignment between the two or more receiver coils and the two or more transmitter coils and geometry of the two or more receiver coils.

15. The vehicular charging system of claim 11, wherein the step of determining magnitude and phase of the sampled current or voltage is based on a frequency analysis.

16. The vehicular charging system of claim 15, wherein the frequency analysis is a Fourier analysis.

17. The vehicular charging system of claim 13, wherein the symmetrical component analysis includes a positive sequence component (I₁ or V₁), a negative sequence component (I₂ or V₂), and a zero sequence component (I₀ or V₀).

18. The vehicular charging system of claim 17, wherein for current measurements, positive sequence component (I₁), a negative sequence component (I₂), and a zero sequence component (I₀) are expressed based on:
$${I}_{0} = \frac{1}{3} ( {I}_{a} + {I}_{b} + {I}_{c} )$$
$${I}_{1} = \frac{1}{3} ( {I}_{a} + {aI}_{b} + {a}^{2} {I}_{c} )$$
$${I}_{2} = \frac{1}{3} ( {I}_{a} + {a}^{2} {I}_{b} + {aI}_{c} )$$
wherein Iₐ represents the measured current for a first phase of the three phases,
I_{b} represents the measured current for a second phase of the three phases,
I_{c} represents the measured current for a third phase of the three phases, and
a is
$${e}^{i \frac{2 π}{3}} .$$

19. The vehicular charging system of claim 17, wherein for voltage measurements, positive sequence component (V₁), a negative sequence component (V₂), and a zero sequence component (V₀) are expressed based on:
$${V}_{0} = \frac{1}{3} ( {V}_{a} + {V}_{b} + {V}_{c} )$$
$${V}_{1} = \frac{1}{3} ( {V}_{a} + {aV}_{b} + {a}^{2} {V}_{c} )$$
$${V}_{2} = \frac{1}{3} ( {V}_{a} + {a}^{2} {V}_{b} + {aV}_{c} )$$
wherein Vₐ represents the measured voltage for a first phase of the three phases,
V_{b} represents the measured voltage for a second phase of the three phases,
V_{c} represents the measured voltage for a third phase of the three phases, and
a is
$${e}^{i \frac{2 π}{3}} .$$

20. The vehicular charging system of claim 11, wherein the two or more transmitter coils include two coils and the two or more receiver coils are energized based on two phases, wherein each of the two or more transmitter coils is coupled to a respective phase
